(19) United States
(12) Patent Application Publication
(10) Pub. No.: US 2010/0144292 A1
(43) Pub. Date: Jun. 10, 2010

(54) ACTIVE RF MODULE

(75) Inventor: Sunkwon Kim, Seoul (KR)

Correspondence Address: RABIN & Berdo, PC, 1101 14TH STREET, NW, SUITE 500, WASHINGTON, DC, 20005, US

(73) Assignee: Max Wireless Co., Seoul (KR)

(21) Appl. No.: 12/065,222

(22) PCT Filed: Nov. 7, 2007
(86) PCT No.: PCT/KR07/05587

§ 371 Date: Feb. 28, 2008

(30) Foreign Application Priority Data
Nov. 14, 2006 (KR) 10-2006-0112493

(51) Int. Cl. H04B 1/04

(52) U.S. Cl. 455/129

(57) ABSTRACT

An active radio frequency module which is capable of coping with a wide frequency band or a multiband by applying a control signal to a module including a single antenna and radio frequency circuits. The active RF module varies and adjusts a frequency band according to a desired characteristic by arranging control elements, whose impedance characteristics are varied depending on applied voltage, at locations adapted for frequency characteristics of an antenna, a filter and a power amplifier, and applying a proper direct voltage to the control elements according to an external signal. Accordingly, it is possible to reduce space for RF stages while easily setting a desired frequency characteristic. In addition, the active RF module can be used over a wide range including various wireless terminals and allows reduction of costs and time for development of RF stages.

### TECHNICAL FIELD

The present invention relates to a radio frequency module adaptable for a wireless terminal, and more particularly, to an active radio frequency module which is capable of coping with a wide frequency band or a multiband by applying a control signal to a module including a single antenna and radio frequency circuits.

### BACKGROUND ART

With rapid spread of mobile communication systems and wireless data communications and combination of various kinds of existing radio broadcastings and radio technologies, recently there is a keen need of wireless means which is operable in a multi-frequency band or a wide frequency band.

In particular, in order to support mobile communication systems that use different frequencies and different communication schemes for the same purpose, there is an increasing need to develop and use multiband mobile communication terminals which are capable of using different mobile communication systems when entering from one region into another region or depending on choice of service by a terminal user. However, in such multiband mobile communication terminals, wireless stages (for example, antenna, an RF circuit, etc.) having their own properties are configured in an overlapping manner to operate in the multiband or the wide frequency band, which may result in limitation to minimization and lightweight of mobile communication terminals, and moreover, high costs and power consumption.

For example, a typical quater-wave monopole antenna has to have a length corresponding to a ¼ wavelength, if not it has a very narrow frequency band characteristic. Accordingly, if the antenna is excessively decreased in size as a space for antenna has a tendency to decrease, then it may not have enough space for a plurality of wireless stages needed for a multiband, resulting in deterioration of performance of communication means due to a narrow frequency characteristic.

FIG. 1 is a block diagram showing a typical RF stage having a passive characteristic. As shown in FIG. 1, the RF stage includes an antenna and matching unit 1, a filter 2 that filters signals to be transmitted/received through the antenna and matching unit 1, a power amplifier 3 that amplifies the signals to be transmitted/received, an other RF device unit 4, and a digital signal processing (DSP) and baseband unit 5 that processes transmitted/received signals. Among these components, the antenna and matching unit 1, the filer 2 and the power amplifier 3 have their own frequency characteristics and thus can be optimally used only in their respective designed frequency bands.

FIG. 2 is a graph showing a unique frequency characteristic of the RF stage, which has the passive elements shown in FIG. 1 and is operable in only a portion of a wide targeted frequency band, through a relationship between a frequency and an input reflective coefficient.

Based on the graph shown in FIG. 2, by constructing a plurality of RF blocks using elements showing their own frequency characteristics for their respective frequency bands, as shown in FIG. 3, it is possible to implement an RF stage which can be used in a multiband, as shown in FIG. 4. However, in the RF stage shown in FIG. 4, although another RF device unit 13 and a DSP and baseband unit 14 may be used in common, antenna and matching units 10a to 10c, filters 11a to 11c and power amplifiers 12a to 12c have to be separately configured to meet their respective frequency bands. This requires more space for the plurality of antennas, and moreover, requires switching elements for selectively driving the power amplifiers, which results in configuration complexity, high costs and increase in size.

### DISCLOSURE

### Technical Problem

To simplify the above-mentioned configuration of the RF stage to support the multiband, it is an object of the present invention to provide an active RF module which is capable of improving frequency characteristics and use efficiency of space for RF stages by configuring, as a single module, an antenna and other RF devices having their respective frequency band characteristics and control elements which are added to the antenna and the RF devices and whose impedance characteristics are varied, further configuring a controller to vary the impedance characteristics of the control elements under external control, and controlling the antenna and the RF devices to operate in a variable frequency band by means of the controller.

It is another object of the present invention to provide an active RF module which is capable of implementing, as a general-purpose module, an RF stage which can operate in a desired frequency band according to an external control signal and facilitating RF stage design of a terminal by configuring, as a module, an antenna, a filter and a power amplifier and their respective control elements whose impedance characteristics are varied depending on voltage and making the module have a desired frequency band characteristic by applying a voltage to the control elements according to the external control signal.

It is still another object of the present invention to provide an active RF module which is capable of varying and adjusting a frequency band according to a desired characteristic by arranging control elements, whose impedance characteristics are varied depending on voltage, at locations adapted for frequency characteristics of an antenna, a filter and a power amplifier, and applying a proper direct voltage to the control elements according to an external signal.

It is still another object of the present invention to provide an active RF module which is capable of operating in a desired multiband or wideband by configuring a general-purpose module by applying one or more control elements to different locations of one or more of an antenna, a filter and a power amplifier, and adjusting a frequency characteristic of the module with a control signal according to a desired use of the module, with impedance of control element, which is not required to be controlled, fixed at a predetermined value.

### Technical Solution

To accomplish the above objects, according to an aspect of the present invention, there is provided an active RF module including: a first layer including an antenna and matching unit; a second layer including a filter having a frequency characteristic corresponding to the first layer; a third layer including a power amplifier having a frequency characteristic corresponding to the first layer and the second layer; one or more voltage controlled variable impedance elements that are connected in series or in parallel to control elements added to one or more of the first to third layers or are configured as substitutes for the control elements; and a controller that varies frequency band characteristics of the one or more layers including the one or more voltage controlled variable impedance elements by applying an output voltage produced according to an external control signal to the one or more voltage controlled variable impedance elements.

Preferably, the voltage controlled variable impedance element is selected from elements including a variable capacitor or a varactor diode, etc. having impedance varied depending on an applied direct voltage.

Preferably, the controller includes means for detecting a frequency characteristic change of one of the first to third layers as the external control signal and automatically adjusting frequency characteristics of the remaining layers.

According to another aspect of the present invention, there is provided an active RF module including: an RF circuit section that is disposed on a board on which signal lines and a ground are formed and includes an RF signal processing circuit including at least one first voltage controlled variable impedance element; a filter that is formed to be separated from the board and includes a filtering circuit connected to the RF circuit section; an antenna that is formed to be separated from the filter and is connected to the signal lines of the board via the filter through an antenna feeder; a second voltage controlled variable impedance element that is applied as a filtering circuit element to the filter or is connected between the antenna and the ground; and a controller that generates a variable voltage according to an external control signal and applies the variable voltage to the first and second voltage controlled variable impedance elements.

Preferably, the RF circuit section further includes a switch for varying a frequency characteristic according to the external control signal, and

wherein the controller includes means for regarding a signal from the switch as the external control signal, varying a voltage applied to at least one of the first and second voltage controlled variable impedance elements according to a frequency characteristic change of the RF circuit section, and matching frequency characteristics of the filter and the antenna to the frequency characteristic of the RF circuit section.

According to still another aspect of the present invention, there is provided an active RF module including: an RF circuit section that is disposed on a board on which signal lines are formed and includes an RF signal processing circuit including at least one element whose impedance is varied depending on an applied voltage; a filter that includes at least one voltage controlled variable impedance element connected to the RF circuit section; an antenna that includes a voltage controlled variable impedance element interposed between a portion of an antenna radiating structure connected to the filter and a ground; and an external connection electrode section that includes a plurality of electrodes electrically connected to the voltage controlled variable impedance elements for applying a voltage from the outside to the voltage controlled variable impedance elements.

According to still another aspect of the present invention, there is provided an active RF module including: a ground substrate; a multiband antenna radiating structure that is disposed to be separated from the ground substrate; a short circuit section that connects the multiband antenna radiating structure to the ground substrate; a feeder that is connected to the multiband antenna radiating structure for signal exchange; at least one voltage controlled variable impedance element that is interposed between at least one of band regions of the multiband antenna radiating structure having highest current density in a predetermined multiband and the ground substrate; and a bandpass filter that is connected to the feeder and uses a voltage controlled variable impedance element as a portion of the bandpass filter.

Preferably, the active RF module further includes a protection structure that protects the components while exposing signal lines and electrodes for controlling the voltage controlled variable impedance elements, as an interface means, to the outside.

### ADVANTAGEOUS EFFECTS

As described above, the active RF module is capable of supporting a multiband or a wide band and minimizing space for RF stages by configuring, as a single module, an antenna and other RF devices having their respective frequency band characteristics and control elements which are added to the antenna and the RF devices and whose impedance characteristics are varied, and further configuring a controller to vary the impedance characteristics of the control elements under external control, and controlling the module according to an external control signal.

In addition, the active RF module is capable of implementing, as a general-purpose module, an RF stage which can operate in a desired frequency band according to an external control signal and facilitating RF stage design of a terminal by configuring, as a module, an antenna, a filter and a power amplifier and their respective control elements whose impedance characteristics are varied depending on applied voltage and making the module have a desired frequency band characteristic by applying a voltage to the control elements according to the external control signal.

In addition, the active RF module is capable of varying and adjusting a frequency band according to a desired characteristic by arranging control elements, whose impedance characteristics are varied depending on applied voltage, at locations adapted for frequency characteristics of an antenna, a filter and a power amplifier, and applying a proper direct voltage to the control elements according to an external signal.

Moreover, the active RF module is capable of operating in a desired multiband or wideband by configuring a general-purpose module by applying one or more control elements to different locations of one or more of an antenna, a filter and a power amplifier, and adjusting a frequency characteristic of the module with a control signal according to a desired use of the module, with impedance of control element, which is not required to be controlled, fixed at a predetermined value.

### DESCRIPTION OF DRAWINGS

FIG. 1 is a block diagram showing a structure of a narrow band RF system.

FIG. 2 is a graph showing a frequency characteristic of the RF system shown in FIG. 1.

FIG. 3 is a block diagram showing a structure of a wideband/multiband RF system.

FIG. 4 is a graph showing a frequency characteristic of the RF system shown in FIG. 3.

FIG. 5 is a block diagram showing a basic configuration of an RF system according to an embodiment of the invention.

FIG. 6 is a graph showing a frequency characteristic of the RF system according to one embodiment of the invention.

FIG. 7 is a conceptual view showing a configuration of an active RF module according to another embodiment of the invention.

FIG. 8 is a perspective view showing a structure of an active RF module according to another embodiment of the invention.

FIG. 9 is a conceptual view for explaining a control method by a controller according to an embodiment of the invention.

FIG. 10 is graphs showing variations of resonance points in the active RF module shown in FIG. 8.

FIG. 11 is a perspective view showing a structure of an active RF module according to still another embodiment of the invention.

FIGS. 12 to 14 are graphs showing variations of resonance points in the active RF module shown in FIG. 11.

FIG. 15 is a circuit diagram showing an exemplary configuration of an active bandpass filter according to an embodiment of the invention.

FIG. 16 is a graph showing a filter characteristic change of the active bandpass filter shown in FIG. 15, when measured while varying impedance of a control element according to an embodiment of the invention.

<Illustration Of Reference Numbers For Principal Parts OF Drawings>

| | |
|---|---|
| 20: active RF module | 21: antenna and matching unit |
| 22: filter | 23: power amplifier |
| 30: controller | 40: other RF device unit |
| 45: DSP and baseband unit | 50: active RF module |
| 51: first layer | 52: second layer |
| 53: third layer | 55: controller |
| 61: main substrate | 62: signal line |
| 63: active and passive element unit | |
| 64: antenna feeder | 65: antenna |
| 66: filter | 67: ground |
| 68: control element | 69: controller |
| 81: ground | 82: short |
| 83: first control element | 84: feeder |
| 85: second control element | 86: antenna |

### MODE FOR INVENTION

Hereinafter, exemplary embodiments of the invention will be described in detail with reference to the accompanying drawings.

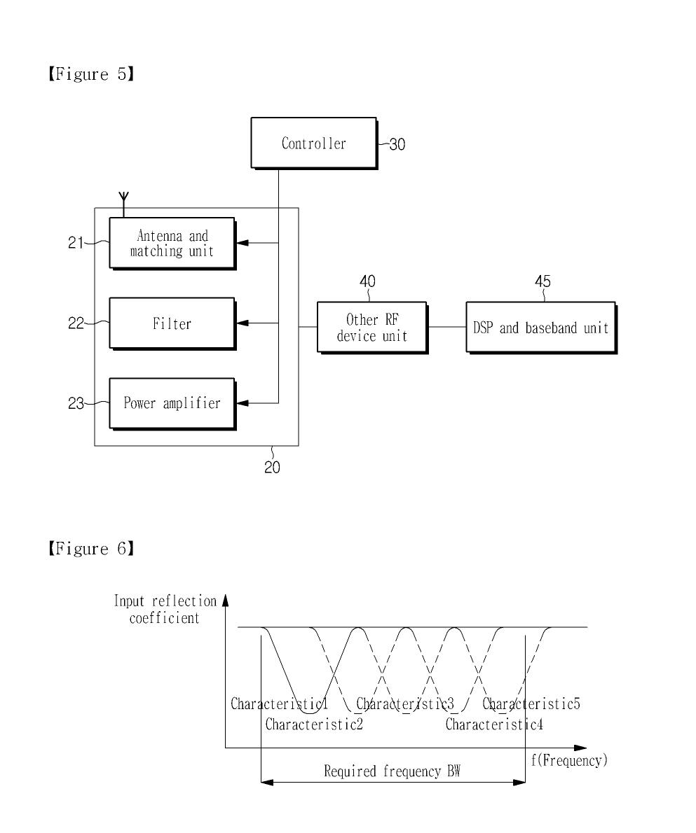

FIG. 5 is a block diagram showing a basic configuration of an RF system according to an embodiment of the invention. As shown in FIG. 5, the RF system includes an active RF module 20, an other RF device unit 40, a baseband unit 45, and a controller that controls the active RF module 20. The active RF module 20 includes an antenna and matching unit 21, a filter 22 and a power amplifier 23. The other RF device unit 40 and the baseband unit 45 do not have much effect on a frequency characteristic of the RF system.

In the active RF module 20, the antenna and matching unit 21 is so configured that an frequency band and a resonance point of an antenna can be varied by a voltage control, the filter 22 is so configured that a passband can be varied by a voltage control, and the power amplifier 23 is so configured that a frequency characteristic can be varied by a voltage control. The controller 30 is used to control various components of the active RF module 20 to obtain desired frequency bands and resonance characteristics. Although the controller 30 is shown to be separated from the active RF module 20 in the above configuration, the controller 30 may be incorporated into the active RF module 20.

FIG. 6 shows a frequency characteristic obtainable in the configuration shown in FIG. 5. When the controller 30 controls the shown active RF module 20 properly, the frequency characteristic of the RF stage can be varied to any frequency band in a range of total required frequency band, as shown in FIG. 6.

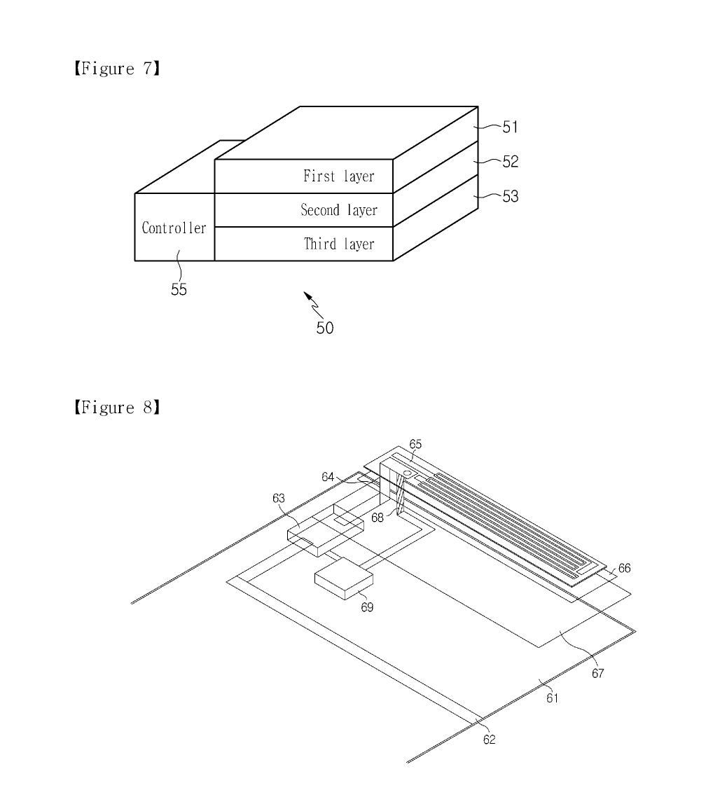

FIG. 7 is a conceptual view showing a basic configuration of an active RF module 50, which may include a controller 55, according to an embodiment of the invention. As shown in FIG. 7, the active RF module 50 may have a first layer 51 including an antenna whose band characteristic is varied depending on a resonance frequency, a second layer 52 including a filter whose passband characteristic is varied to filter signals according to the band characteristic varied by the first layer 51, and a third layer 53 including a matching unit, a power amplifier and an other RF device to process RF signals according to frequency characteristics obtained by the antenna and the filter. The controller 55 varies frequency characteristics of at least the first layer 51 and the second layer 53, and can adjust a frequency characteristic of the third layer 53, if necessary.

In actuality, the layers 51 and 53 are configured to include respective elements whose impedance is varied by a voltage in order to vary the frequency characteristics under control by the controller 55. Examples of the elements having such variable impedance may include a variable capacitor, a varactor diode, etc. whose impedance is varied under application of a constant direct voltage thereto.

As an example, in the antenna of the first layer 51, if a variable impedance element is inserted in an antenna radiating plate, a resonance frequency and a frequency band of the antenna are varied as the impedance of the variable impedance element is gradually decreased from infinity. To this end, the controller 55 may be configured to control a direct voltage applied to the variable impedance element.

As another example, in the filter included in the second layer 52, if an element (for example, a capacitor) composing a low pass filter or a high pass filter (for example, an RC filter) or a resonance circuit (for example, an LC filter) is replaced with a variable impedance element (for example, a variable capacitor), a frequency in a filtering region is varied when the impedance of the variable impedance element is adjusted. Similarly, the impedance of this variable impedance element may be determined by a direct voltage provided by the controller 55. Of course, variations of the impedance to the direct voltage in the above-mentioned variable impedance elements may depend on a required variable frequency region, and various RF processing means included in the third layer 53 may be applied with variable impedance elements in order to obtain desired frequency characteristics.

The controller 55 has the function to apply a preset voltage to the variable impedance elements included in the above layers for itself or according to an external control signal. The controller 55 may include a digital-analog converter, or alternatively switches to select a desired one of several constant voltages. The controller 55 may further include various additional elements (for example, an operational amplifier, a logic circuit, a memory, etc.) to support the function of the converter or the switches.

For example, if the controller 55 adjusts the variable impedance elements included in the first to third layers to be adapted to desired bands according to a control signal provided from the outside, since voltages applied to the variable impedance elements may be either the same or different, sets of control voltages for the variable impedance elements may be stored in a memory, read therefrom, and applied to provide frequency characteristics corresponding to the control signal. As an alternative, the controller 55 may perform only the function to provide a voltage for the variable impedance elements, and the control signal may be provided from the outside. As another alternative, the controller 55 may control only predetermined variable impedance elements while a constant voltage is provided to variable impedance elements to be fixed to a specified value (for example, by setting a switch).

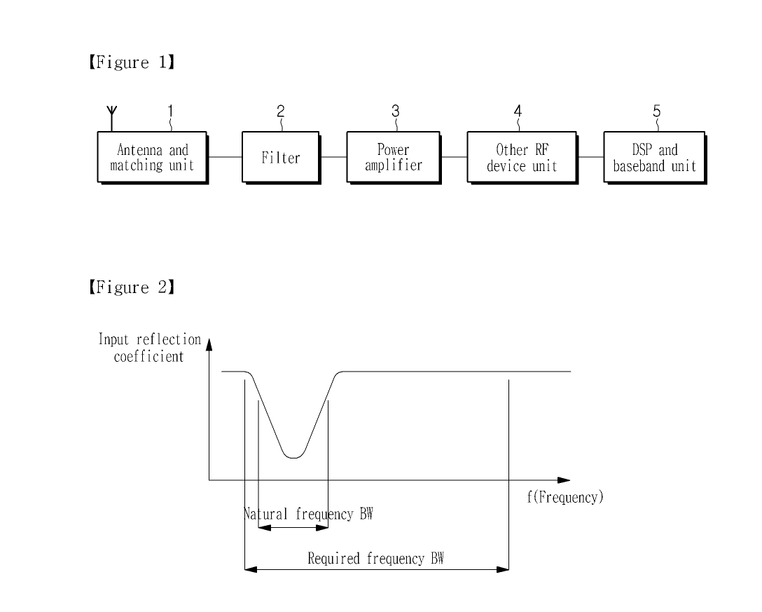

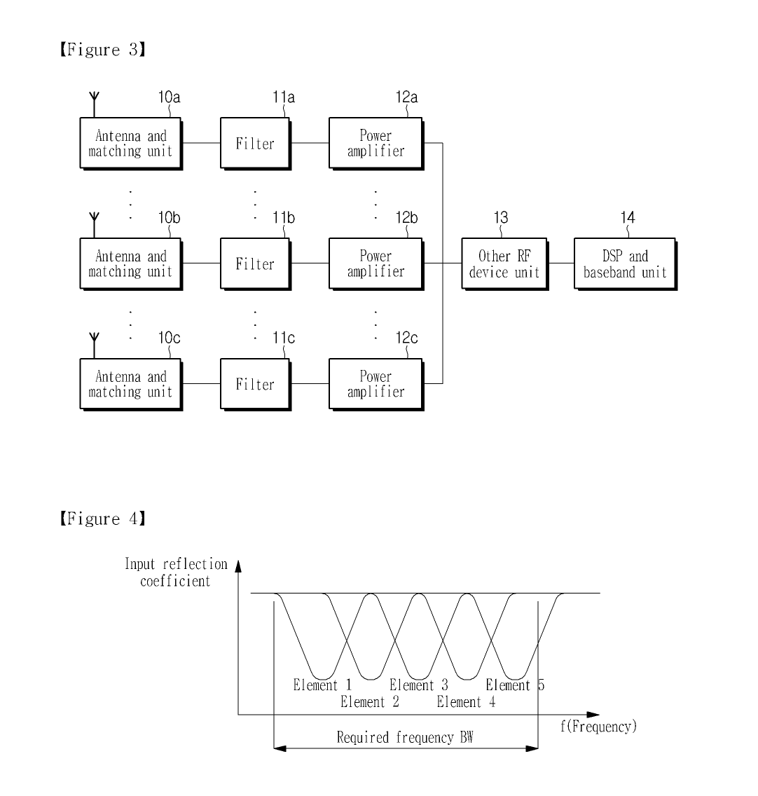

FIG. 8 shows a structure of an active RF module according to a first embodiment of the invention. As shown in FIG. 1, control elements as variable impedance elements are added to an RF stage, and a controller 69 controls the control elements. For the sake of brevity, this figure does not show details of a control signal provided to the controller 69.

First, as shown in FIG. 8, an active and passive element unit 63 composed of active elements and passive elements is connected to a signal line 62 formed on a main substrate 61, and the active and passive element unit 63 is connected to an antenna 65 through an antenna feeder 64. The antenna 65 is preferably a PIFA (Planner Inverted-F Antenna) for use with mobile communication terminals or radio telephones, but may be any antenna having different structures. A filter 66 is formed between the antenna 65 and the main substrate 61, and the above devices are connected to a ground 67. If necessary, a power amplifier may be formed in a space in which the antenna 65 and the filter 66 are accommodated. With this configuration, current applied to the signal line 62 is supplied to the antenna 65 and the filter 66 via the active and passive element unit 63. One or more current sources may be used. If a plurality of current sources are used, the antenna 65, the filter, and, if any, the power amplifier are connected to respective current sources.

A variable impedance element (also referred to as ‘control element’) is interposed between the antenna 65 and the ground 67. If necessary, a control element may be added to the filter 66. In addition, a control element is added to the active and passive element unit 63. The controller 69 controls the control element added to the active and passive element unit 63 and the control element 68 connected to the antenna 65 at once or separately.

For example, assuming that the shown RF module includes an antenna 65 and a filter 66 operating in a CDMA band, when the impedance of a control element included in an active and passive device 63 or the impedance of a control element 68 connected to the antenna 65 is varied, the antenna 65 and the filter 66 may be configured to operate in a GSM band as well as the CDMA band. At this time, when a switch is simply added to the active and passive device 63 and its frequency characteristic is varied with operation of the switch, the controller may be configured to recognize the operation of the switch, adjust the control element 68 connected to the antenna 65, and automatically adjust the frequency characteristic of the antenna 65 (including the filter 66 and the power amplifier if they has their respective control elements) to the active and passive element unit 63 whose frequency characteristic is varied according to the operation of the switch. That is, when frequency characteristics of some of RF elements in the active RF module are varied, frequency characteristics of the remaining RF elements can be self-tuned.

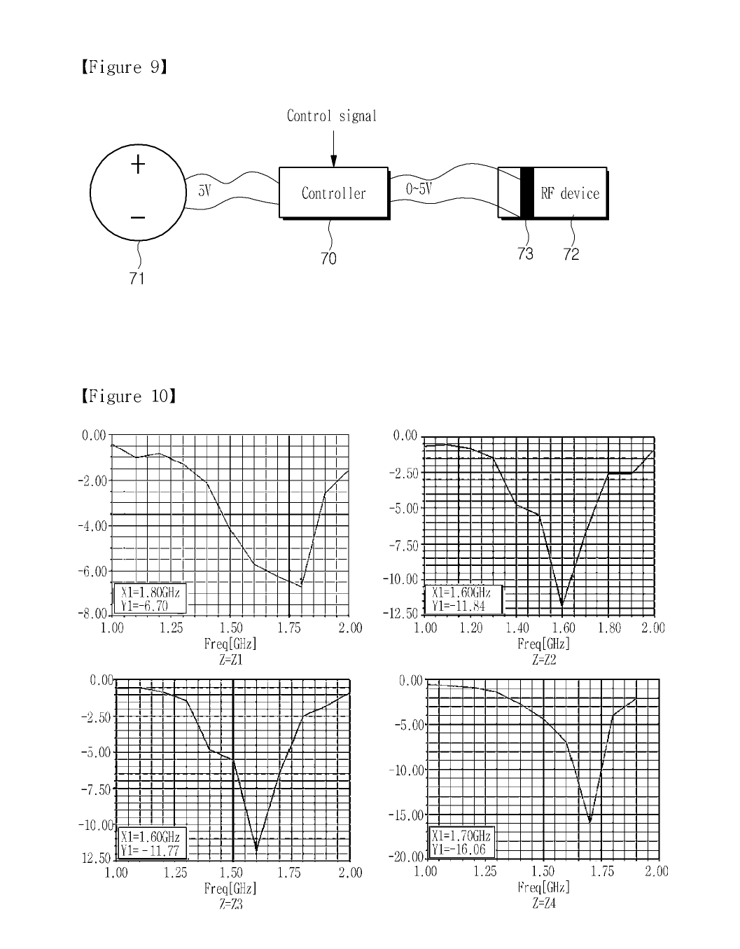

FIG. 9 shows how to vary frequency characteristic of a control element using an external control signal. As shown in FIG. 9, when a controller 70 adjusts a voltage received from a direct voltage source 71 to be a predetermined voltage based on an external control signal and applies the predetermined voltage to a control element 73 included in or connected to an RF device 72, the impedance of the control element 73 is varied, and accordingly, the total impedance and a frequency characteristic of the RF device 72 is varied. For example, if a 5V direct voltage source is used, the controller 70 generates a voltage of 0 to 5V to adjust the impedance of the control element 73. The controller 70 may include a digital-analog converter, a voltage adjusting means or a switch to convert the source voltage into any voltage.

FIG. 10 shows variations of resonance points of the antenna shown in FIG. 8 depending on the impedance Z of the control element 68 inserted in the antenna 65. It can be seen from FIG. 10 that resonance points and bandwidth are varied depending on the impedance Z of the control element. Specifically, FIG. 10 shows significant variations of the resonance points and bandwidth of the antenna for four different impedances Z1 to Z4 of the control element inserted in the antenna.

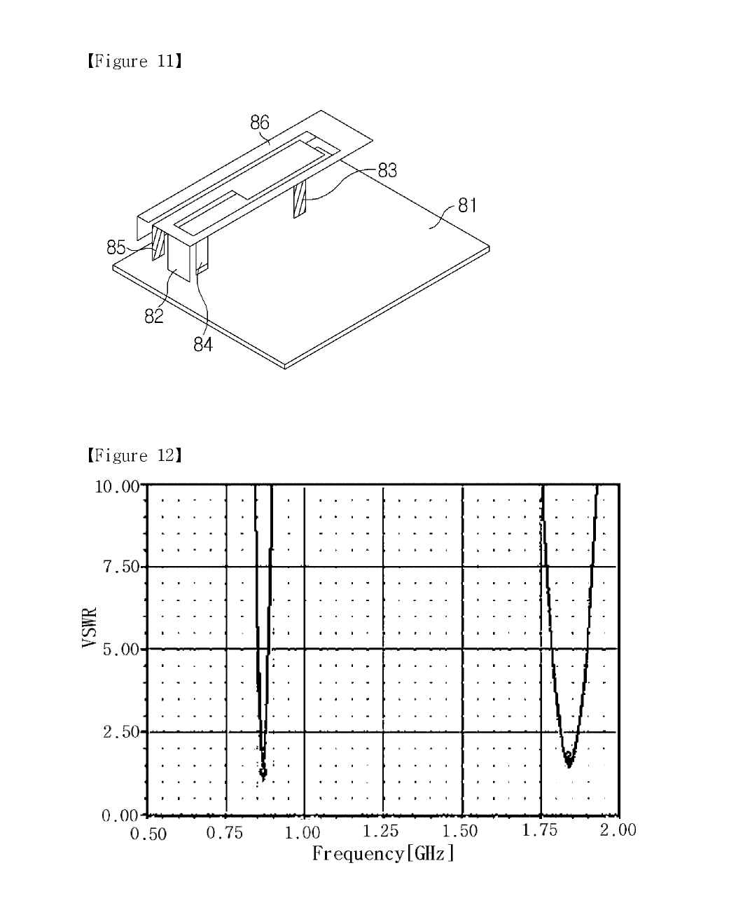

FIG. 11 shows a structure of an active RF module having an antenna added with a plurality of control elements according to a second embodiment of the present invention. Although not shown in this figure, a plurality of control elements can be added to a filter and other RF devices.

The shown antenna is a PIFA antenna which can be used as a dual band antenna. As shown in FIG. 11, an antenna (including an antenna radiating structure) 86 is connected to a ground 81 via a conductive connection. In addition to a feeder 84 for the antenna 86, a first control element 83 and a second control element 85 are formed at different locations. The first control element 83 and the second control element 85 are interposed between the antenna 86 and the ground 81, and a controller (not shown) adjusts the impedance of the first and second control elements 83 and 85 by applying a direct voltage thereto. At this time, the first and second impedance elements 83 and 85 have to provide high impedance equivalent to an electrical open under control of the controller. If necessary, the first and second control elements 83 and 85 may have different impedances depending on voltage.

The antenna 86, which is typically a dual band PIFA antenna, has different current density increase regions when the antenna is used in low and high frequency bands. That is, current density of a portion to which the first control element 83 is connected increases when the antenna is used in the low frequency band, while current density of a portion to which the second control element 85 is connected increases when the antenna is used in the high frequency band. In other words, when varying the impedances of the control elements 83 and 85 to be connected to portions having high current density in the frequency bands in which the antenna 86 is used, variations in the frequency bands of the antenna 86 are increased.

FIG. 12 shows a unique impedance characteristic of the antenna 86 when the impedance of the first and second control elements 85 is increased to an electrical open in the configuration shown in FIG. 11. It can be seen from FIG. 12 that the antenna 86 has a narrow dual band characteristic.

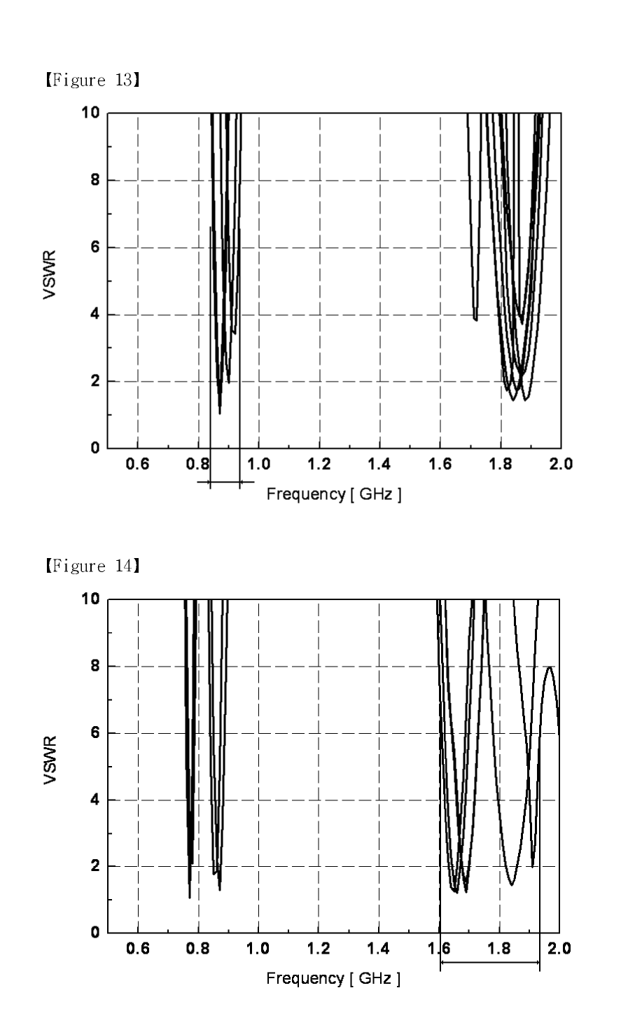

FIG. 13 shows a case where the impedance of the first control element 83 is varied and the second control element 85 remains in an electrical open state in the configuration shown in FIG. 11. It can be seen from FIG. 13 that a very narrow low frequency band in FIG. 12 is significantly increased.

FIG. 14 shows a case where the impedance of the second control element 85 is varied and the first control element 83 remains in an electrical open state in the configuration shown in FIG. 11. It can be seen from FIG. 14 that a relatively narrow high frequency band in FIG. 12 is significantly increased.

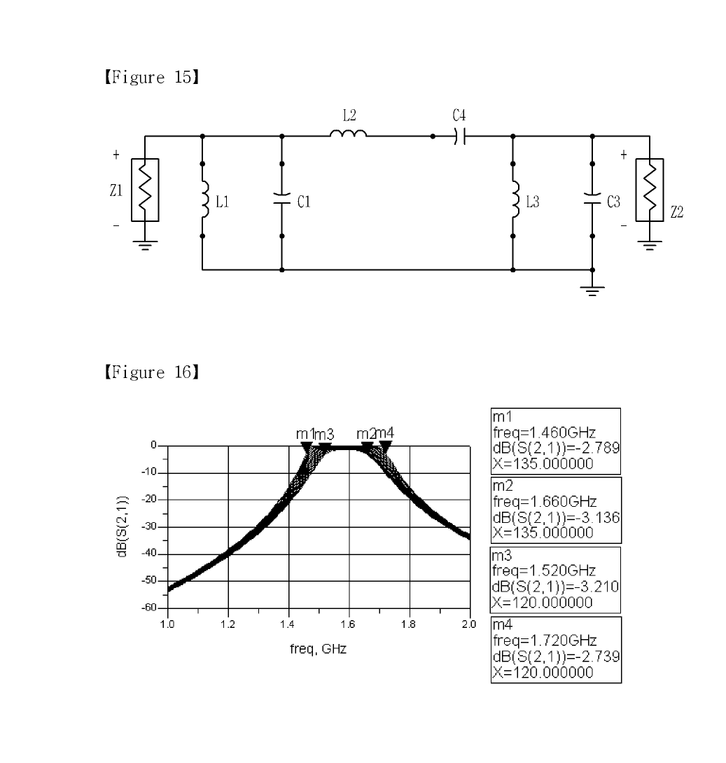

FIG. 15 shows an exemplary filter circuit to which a control circuit is applied. As shown in FIG. 15, in a bandpass filter constructed by an LC resonance circuit including inductors and capacitors, one of the capacitors is replaced with a variable capacitor C4 which is then used as a control element to vary a frequency characteristic of the filter.

Although one variable capacitor C4 is shown, if necessary, other capacitors C1 and C3 may be replaced with variable capacitors whose impedance is varied depending on applied voltage, thereby obtaining more diverse variations of frequency characteristic of the filter.

FIG. 16 shows a filter characteristic change of the bandpass filter shown in FIG. 15, when the impedance of the variable capacitor C4 shown in FIG. 15 is varied by applying a voltage thereto. As shown in FIG. 16, four boundary frequencies can be obtained by adjusting the impedance of the variable capacitor C4. That is, it can be seen from FIG. 16 that a bandpass characteristic of the filter can be finely adjusted from a 1.46 GHz to 1.66 GHz band to a 1.52 GHz to 1.72 GHz band by adjusting the impedance of the variable capacitor C4.

As described above, after configuring a module by applying or adding the control elements whose impedance can be adjusted depending on applied voltage to some components (for example, an antenna, a filter, a power amplifier, a matching unit, etc.) in an RF stage, and then by together or separately configuring the controller to vary the impedance by applying a voltage to these control elements, the frequency characteristic of the module can be adjusted according to a control signal provided to the controller, or the controller can detect a frequency characteristic change of some of the control elements and automatically tune frequency characteristics of the remaining control elements based on the detection. Accordingly, even a small module can be used to configure an RF stage for multiband or wideband RF communication. In particular, by further configuring a protection structure enclosing the active RF module while exposing signal lines to an interface, the signal lines for providing a control signal to the controller or providing a control signal (for example, a signal for switch operation) to change frequencies of the control elements, the active RF module can be implemented as an independent single module. In addition, if an active RF module is configured without the controller, the active RF module can be implemented as a single module by further configuring a protection structure enclosing the module while exposing control signal lines of the control elements included in the active RF module to an interface.

With the use of the protection structure, in the configuration where the controller is included, the frequency characteristic of the active RF module can be easily changed by applying an external control signal to the controller. On the other hand, in the configuration where the controller is not included, the frequency characteristic of the active RF module can be varied by making unnecessary ones of various pre-configured control elements electrically open (for example, for a control element inserted in an antenna) or have fixed impedance (for all the control elements) by applying a constant voltage from the outside of the module, and then applying a proper voltage to necessary control elements using external control means. In other words, the active RF module can be used over a wide range including various wireless terminals and allows reduction of costs and time for development of RF stages.

1. An active RF module comprising:
a first layer including an antenna and matching unit;
a second layer including a filter having a frequency characteristic corresponding to the first layer;
a third layer including a power amplifier having a frequency characteristic corresponding to the first layer and the second layer;
one or more voltage controlled variable impedance elements that are connected in series or in parallel to control elements added to one or more of the first to third layers or are configured as substitutes for the control elements; and
a controller that varies frequency band characteristics of the one or more layers including the one or more voltage controlled variable impedance elements by applying an output voltage produced according to an external control signal to the one or more voltage control variable impedance elements.

2. The active RF module according to claim 1, wherein the controller applies different voltages to the one or more voltage controlled variable impedance elements according to the external control signal.

3. The active RF module according to claim 1, wherein the voltage controlled variable impedance element is selected from elements including a variable capacitor or a varactor diode, etc. having impedance varied depending on an applied direct voltage.

4. The active RF module according to claim 1, wherein the voltage controlled variable impedance element is configured in plural number in at least one of the first to third layers.

5. The active RF module according to claim 1, wherein the one or more voltage controlled variable impedance elements are interposed between an antenna radiating structure of the antenna of the first layer and a ground.

6. The active RF module according to claim 5, wherein the voltage controlled variable impedance elements are interposed between a portion of the antenna radiating structure having highest current density in a predetermined frequency band and the ground.

7. The active RF module according to claim 5, wherein the voltage controlled variable impedance element provides high impedance corresponding to electrical open under control of the controller.

8. The active RF module according to claim 1, wherein the controller includes means for detecting a frequency characteristic change of one of the first to third layers as the external control signal, changing a voltage applied to voltage controlled variable impedance elements of the remaining layers based on preset information according to the external control signal, and automatically adjusting frequency characteristics of the remaining layers to the frequency characteristic of the layer whose frequency characteristic change is detected.

9. An active RF module comprising:
an RF circuit section that is disposed on a board on which signal lines and a ground are formed and includes an RF signal processing circuit including at least one first voltage controlled variable impedance element;
a filter that is formed to be separated from the board and includes a filtering circuit connected to the RF circuit section;
an antenna that is formed to be separated from the filter and is connected to the signal lines of the board via the filter through an antenna feeder;
a second voltage controlled variable impedance element that is applied as a filtering circuit element to the filter or is connected between the antenna and the ground; and
a controller that generates a variable voltage according to an external control signal and applies the variable voltage to the first and second voltage controlled variable impedance elements.

10. The active RF module according to claim 9, wherein each of the first and second voltage controlled variable impedance elements is a variable capacitor or a varactor diode.

11. The active RF module according to claim 9, wherein the controller applies different voltages to the first and second voltage controlled variable impedance elements according to the external control signal.

12. The active RF module according to claim 9, wherein the RF circuit section further includes a switch for varying a frequency characteristic according to the external control signal, and
wherein the controller includes means for regarding a signal from the switch as the external control signal, varying a voltage applied to at least one of the first and second voltage controlled variable impedance elements according to a frequency characteristic change of the RF circuit section, and matching frequency characteristics of the filter and the antenna to the frequency characteristic of the RF circuit section.

13. The active RF module according to claim 9, wherein the second voltage controlled variable impedance element includes a first element that is applied as a filtering circuit element to the filter and a second element that is connected between the antenna and the ground.

14. The active RF module according to claim 9, wherein the RF circuit section includes a power amplifier that includes a variable impedance element.

15. The active RF module according to claim 9, wherein the controller provides a preset single voltage value or a set of different preset voltage values to the first and second voltage controlled variable impedance elements according to the external control signal and changes a bandwidth and a resonance point to a preset value based on the preset single voltage value or the set of different preset voltage values.

16. The active RF module according to claim 9, wherein the controller includes a plurality of switches for selectively applying the preset voltages to the first and second voltage controlled variable impedance elements according to the external control signal.

17. The active RF module according to claim 9, wherein the second voltage controlled variable impedance element is configured in plural number for each of the filter and the antenna, and variable impedance values of the plurality of the second voltage controlled variable impedance elements are differently set depending on a voltage.

18. The active RF module according to claim 17, wherein the plurality of the second voltage controlled variable impedance elements connected to the antenna are respectively connected between a portion of the antenna having highest current density in a predetermined frequency band and the ground.

19. The active RF module according to claim 17, wherein the plurality of the second voltage controlled variable impedance elements connected to the filter are used instead of capacitors used in the filter.

20. The active RF module according to claim 17, wherein the second voltage controlled variable impedance element provides high impedance corresponding to electrical opening according to a voltage from the controller.

21. An active RF module comprising:
an RF circuit section that is disposed on a board on which signal lines are formed and includes an RF signal processing circuit including at least one element whose impedance is varied depending on a voltage;
a filter circuit section that includes at least one voltage controlled variable impedance element connected to the RF circuit section;
an antenna that includes a voltage controlled variable impedance element interposed between a portion of an antenna radiating structure connected to the filter and a ground; and
an external connection electrode section that includes a plurality of electrodes electrically connected to the voltage controlled variable impedance elements for applying a voltage from the outside to the voltage controlled variable impedance elements.

22. The active RF module according to claim 21, wherein the external connection electrode section further includes a protection structure that exposes an interface means to the outside but does not expose other components to the outside.

23. An active RF module comprising:
a ground substrate;
a multiband antenna radiating structure that is disposed to be separated from the ground substrate;
a short circuit section that connects the multiband antenna radiating structure to the ground substrate;
a feeder that is connected to the multiband antenna radiating structure for signal exchange;
at least one voltage controlled variable impedance element that is interposed between at least one of band regions of the multiband antenna radiating structure having highest current density in a predetermined multiband and the ground substrate; and
a bandpass filter that is connected to the feeder and uses a voltage controlled variable impedance element as a portion of the bandpass filter.

24. The active RF module according to claim 23, further comprising a controller that applies a variable direct voltage to the voltage controlled variable impedance elements according to an external control signal.

25. The active RF module according to claim 23, further comprising a protection structure that protects the components while exposing signal lines and electrodes for controlling the voltage controlled variable impedance elements, as an interface means, to the outside.
